(19) United States
(12) Patent Application Publication
(10) Pub. No.: US 2003/0055852 A1
(43) Pub. Date: Mar. 20, 2003

(54) Reconfigurable arithmetic logic block array for FPGAs

(76) Inventor: Mathew Francis Wojko, Anna Bay (AU)

Correspondence Address: FALK AND FISH, 16590 OAK VIEW CIRCLE, MORGAN HILL, CA, 95037, US

(21) Appl. No.: 09/957,147

(22) Filed: Sep. 19, 2001

(51) Int. Cl. G06F 7/38

(52) U.S. Cl. 708/230; 708/490

(57) ABSTRACT

An arithmetic logic block which can selectively perform either logical or arithmetic operations or both on 4-bit or 8-bit or larger binary quantities received at operand input buses. Boolean AND, OR and exclusive-OR operations can be performed on 8-bit binary numbers and 8-bit binary numbers can be buffered. Up to four 4-bit numbers can be added, and 4-bit or 8-bit numbers may be added or subtracted. Binary multiplication or addition of n-bit numbers can accomplished with fewer ALBs than the prior art by connection of the ALBs of the invention into a suitable array.

### BACKGROUND OF THE INVENTION

Field Programmable Gate Arrays (hereafter FPGA) have grown in popularity because of their flexibility because they can be programmed to implement particular logic operations and reprogrammed easily as opposed to an application specific integrated circuit (hereafter ASIC) where the functionality is fixed in silicon. However, because FPGAs have to be generic in design so that they can be used in many different applications, the designs of the individual logic blocks used in the FPGAs are made fairly generic also.

The generic nature of the design of the logic blocks has certain disadvantages. For example, if an FPGA is to be programmed to implement any application which is arithmetically intensive such as a finite impulse response filter, the density of the FIR filter is not as high as it would be if the same filter were implemented in an ASIC. This is because the logic blocks of the FPGA typically are designed with one or two-bit multipliers, so it takes a large number of them programmed to be coupled together to implement a complicated, arithmetically intensive design.

A new trend in integrated circuit design is system-on-a-chip solutions which are now in development. Such integrated circuits typically have a digital signal processor, an arithmetic array of FPGAs as well as supporting components such as analog-to-digital converters and digital-to-analog converters. These chips are useful in digital and analog communication systems for signal processing and filtering for applications such as cell phones. By putting all these components on a single chip, the cost of the total cell phone or other system can be driven down. However, prior art FPGAs are not well adapted for such system-on-a-chip designs because they are not efficiently designed for highly intensive mathematical applications such as the computations required for filtering in digital signal processing and encryption and decryption in Virtual Private Networks, Secure Sockets Layer and other LAN and WAN applications. Therefore, a much larger FPGA is needed to do highly mathematical intensive operations. This drives the cost of the system-on-a-chip design up.

System-on-a-chip integrated circuits are highly useful to decrease the cost of systems to do wireless communication systems, digital signal processing, virtual private networks, internet protocol security and data encryption. These systems require one or more of the following mathematical and/or Boolean logic functions and other functions to be performed: DES encryption; triple DES; IDEA—International Data Encryption Association standard for split key encryption as is done in Pretty Good Privacy (PGP) encryption and decryption and Secure Sockets Layer (SSL) encryption and decryption; code division multiple access RAKE receivers; finit impulse response filters; DCT processing for MPEG and JPEG compression; decimation; PN code generation; media access control; addition; multiplication; accumulation; exclusive-OR (XOR); register storage; lookup table and shift register functions.

The problem in supporting all these applications and functions is how to design reconfigurable hardware resources that provide the most effective use of general purpose FPGA silicon for the specific application domain in which the FPGA is put to use. FPGAs are general purpose circuits that can be programmed to perform many different functions. However, the high end digital signal processing world of wireless communication, image processing and secure communications over the internet requires demanding mathematical and Boolean logic operations that are difficult or inefficient to implement with prior art FPGA arithmetic logic block technology.

FPGAs exist in the prior art which have two different types of circuits therein. One type of circuit is a standard FPGA logic block and the other type of circuit is a customizable multiplier. Prior art FPGA logic blocks typically contain a look up table, a single or double bit arithmetic circuit and a register. Prior art logic blocks such as the Altera Flex shown in FIG. 1 contain a look up table 10, a single-bit arithmetic unit 12 and a register 14. Prior art logic blocks such as the Xilinx Virtex CLB slice shown in FIG. 2 contain two look up tables 16 and 18, two single-bit arithmetic circuits 20 and 22 and two registers 24 and 26. The existence of AND gate 17 and data path 19 allow the Xilinx logic block to support multiplication operations slightly more efficiently.

Dynachip also made FPGAs before the assets were acquired by Xilinx. The Dynachip FPGA logic blocks only used 4 of 16 general inputs to any basic cell for arithmetic operations, so it also is not optimized to do mathematically intensive applications.

It appears that neither of these Altera nor Xilinx prior art FPGA logic blocks can do both arithmetic and Boolean logical operations in the same circuit. Further, neither is efficiently designed to be reconfigurable to do a plurality of different arithmetic and Boolean logic operations as wells as providing register, shift register and accumulation capabilities. Further, neither contains circuitry specially designed to do convolution which is a very common operation in digital data communication systems. Further, neither of the Xilinx or Altera logic block has the ability to do addition and subtraction on 4-bit quantities nor do they have the ability to add 4 4-bit values. Further, neither of the Xilinx or Altera logic block has the ability to do Boolean AND, XOR or OR operations between 8-bit operands. Further, neither of the Xilinx or Altera logic block has the ability to store 8-bit quantities in registers. Further, neither of the Xilinx or Altera logic block has the ability to do addition or subtraction two 8-bit quantities. Further, neither of the Xilinx or Altera logic block has the ability to add 4n-bit values in n/(4+1) cells. Further, neither of the Xilinx or Altera logic block has the ability to implement an n×4 bit multiplier in n/(4+1) cells.

The Altera and Xilinx logic block designs are not efficiently designed in that only 50% of the inputs of either logic block can be used for arithmetic operation inputs (although in the Xilinx design, all 8 of 8 can be used in the first part of a multiplication. The prior art DynaChip logic block only have 25% utilization where only 4 of 16 inputs can be used for math operations.

Hewlett Packard has designed an array of arithmetic blocks suitable for multimedia applications. Each block has a 4-bit input, but only do addition or subtraction and could not do multiplication.

Thus, use of existing FPGA arithmetic logic block technology to support complex digital signal processing, wireless and wired broadband and other digital communication and secure digital communications is not efficient.

Therefore there has arisen a need for an FPGA logic block that do both arithmetic and Boolean logical combination operations including multiplication. There is a need for an FPGA logic block which is much more flexible (reconfigurable) and therefore much more efficient than prior art technologies and which can overcome the deficiencies in the Altera and Xilinx logic block designs. Further, there is a need for an FPGA logic block that can be tiled together to implement n×4 bit multipliers and adders which can add 4n-bit values.

### SUMMARY OF THE INVENTION

The genus of the invention is defined by an arithmetic logic block which has the following characteristics: multiple operand input buses; carry-in and carry-out inputs for coupling the ALBs into arrays to multiply or add bigger numbers than the input buses are capable of receiving; a convolver or multiplier circuit which can multiply operands received on the operand buses; at least two adders one of which is an adder and subtractor, and preferably two 4-bit adders and one 8-bit adder and subtractor; and multiple data paths through multiple multiplexers to couple the operand input buses to the Boolean logic combination circuitry, the multiplier and the adders and subtractors and to couple the multiplier to the adders and subtractors to allow partial products to be generated and added together to allow multiplication to be performed. In the preferred species, the arithmetic logic block also includes Boolean logic combination circuitry coupled to the input buses and output and a buffer for storing operands. The multiplier also has an input for receiving 3-bit quantities from the multiplier in a neighboring ALB, and an output to output 3-bit quantities to the multiplier in a neighboring ALB.

A reconfigurable arithmetic logic block according to one species of the invention will have the following elements:

first, second, third and fourth multi-bit operand input buses;

a convolver circuit having first and second inputs coupled to said first and second input buses and having first, second, third and fourth output buses at which multi-bit partial products appear, and having a multi-bit carry input and a multi-bit carry output, each for coupling to neighboring arithmetic logic blocks in an array to allow partial product generation in said array;

a multi-bit Boolean logic means having first and second inputs and an output, said second input coupled to receive the bits on said third and fourth operand input buses for performing a selected operation on the input bits at said first and second inputs and outputting the result at said output;

a first multiplexer having a first input coupled to receive the bits on said first and second operand input buses, and having an output coupled to said first input of said Boolean logic means, and having a second input coupled to receive an output signal from said arithmetic logic block, and having a control input to receive a switching control signal;

a first adder having a first operand input and a second operand input and having an output, and having a carry input and a carry output for coupling to neighboring arithmetic logic blocks;

a second multiplexer having an output coupled to said first operand input of said first adder and having a first input coupled to said third operand input bus and having a second input coupled to said first output of said convolver circuit, and having a control input for receiving a switching control signal;

a third multiplexer having an output coupled to said second operand input of said first adder and having a first input coupled to said fourth operand input bus and having a second input coupled to said second output of said convolver circuit, and having a control input for receiving a switching control signal;

a second adder having a first operand input and a second operand input and having an output, and having a carry input and a carry output for coupling to neighboring arithmetic logic blocks;

a fourth multiplexer having an output coupled to said first operand input of said second adder and having a first input coupled to said first operand input bus and having a second input coupled to said third output of said convolver circuit, and having a control input for receiving a switching control signal;

a fifth multiplexer having an output coupled to said second operand input of said second adder and having a first input coupled to said second operand input bus and having a second input coupled to said fourth output of said convolver circuit, and having a control input for receiving a switching control signal;

a third adder having a first operand input and a second operand input and having an output, and having a carry input and a carry output for coupling to neighboring arithmetic logic blocks;

a sixth multiplexer having an output coupled to said first operand input of said third adder and having a first input coupled to receive the bits of said first and second operand input buses and having a second input coupled to said output of said first adder, and having a control input for receiving a switching control signal;

a seventh multiplexer having an output coupled to said second operand input of said third adder and having a first input coupled to receive the bits of said third and fourth operand input buses and having a second input coupled to said output of said second adder, and having a control input for receiving a switching control signal;

an eighth multiplexer having a first input coupled to said output of said Boolean logic means and having a second input coupled to said output of said third adder, and having an output and a control input to receive a switching control signal;

a register having a data input coupled to said output of said eighth multiplexer and having an output; and

a ninth multiplexer having a first input coupled to said output of said register, and having a second input coupled to said output of said eighth multiplexer and having an output coupled to said second input of said first multiplexer and also serving as the output of said arithmetic logic block.

### BRIEF DESCRIPTION OF THE DRAWINGS

FIG. 1 is a block diagram of the prior art Altera Flex arithmetic logic block.

FIG. 2 is a block diagram of the prior art Xilinx Virtex CLB Slice arithmetic logic block.

FIG. 3 is a block diagram of the preferred species of a reconfigurable logic block within the genus of the invention.

FIG. 4 illustrates how two 8-bit quantities can be added, subtracted, combined by exclusive-OR or a simple OR operation.

FIG. 5 illustrates how 4 4-bit values can be added.

FIG. 6 illustrates how partial products are generated and added in the multiplication of two 4-bit numbers using two ALB circuits like that shown in FIG. 3.

FIG. 7 represents a partial product array generated by a row of ALBs according to the invention for an 8×8 binary multiplication.

FIG. 8 shows in block form the array of 6 ALBs that are used to form the partial products of the 8×8 multiply operation.

FIG. 9 shows how the first three ALBs in the array of FIG. 8 form the first row and ALBs 4, 5 and 6 form a second row. ALB 1 through ALB 3 forms an 8×4 multiplier, and ALB 4 through ALB 6 forms another 8×4 multiplier.

FIG. 10 shows how ALBs of the invention can be configured to form a binary tree to add k n-bit numbers to perform the additions of the partial products of FIG. 7.

FIG. 11 is a block diagram of a finite impulse response filter.

FIG. 12 is a table illustrating how less hardware can be used if the FIR filter of FIG. 11 is implemented with the ALB of FIG. 3 as compared to being implemented with a prior art ALB structure.

### DETAILED DESCRIPTION OF THE PREFERRED AND ALTERNATIVE EMBODIMENTS

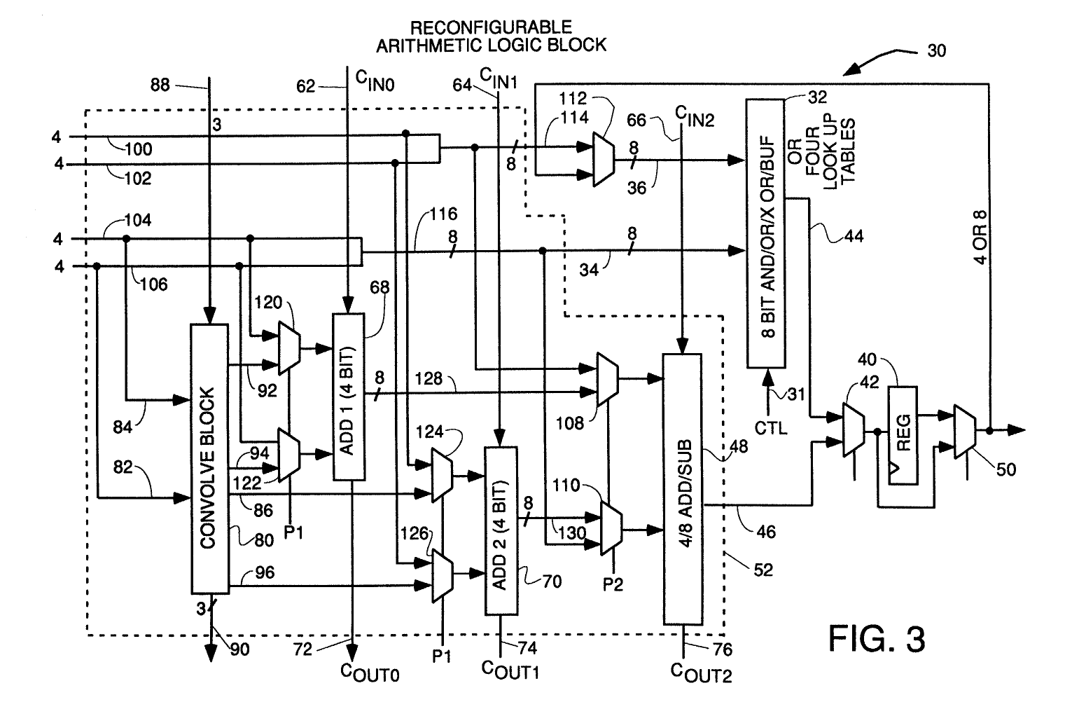

Referring to FIG. 3, there is shown a block diagram of one species of the improved reconfigurable arithmetic logic block 10. General Boolean combinatorial logical operations are performed in an 8-bit logic circuit 32. In some embodiments, circuit 32 is circuitry that can perform 8-bit addition, subtraction or multiplication between the 8-bit quantities on input buses 34 and 36. However, in the preferred embodiment, circuit 32 can performs Boolean logical AND, OR, XOR operations between the quantities on buses 34 and 36 or buffers the data on these buses. A control signal on bus 31 controls which operation the circuit 32 performs. In the preferred embodiment, circuit 32 is implemented with four four-input look up tables that output the results for any of the mathematical or logical operations circuit 32 can perform as the result of application to the inputs of any combination of bits. Any number of lookup tables could be used such that one look up table would be dedicated to each mathematical or logical function supported, or one lookup table that is programmed on the fly to do the currently needed mathematical or logical operation could be used. The use of look up tables is preferred since they allow a more dense implementation and allow more functions to be performed for the amount of die area consumed.

Circuit 32 provides the general Boolean logic combinational capability of the arithmetic logic block (ALB) 30. Register 40 provides the register storage capability of the ALB. Multiplexer 42 provides selection of the output 44 of circuit 32 or the output 46 of circuit 48 for storage in register 40. Multiplexer 50 allows register 40 to be bypassed.

The arithmetic capability of ALB 30 is provided by the circuitry inside dashed line 52. The difference between the arithmetic circuitry 52 and the prior art is that 4-bit or 8-bit quantities may be added or subtracted as opposed to the 1-bit or 2-bit math the prior art ALBs perform. Also, more dense multiplications can be performed.

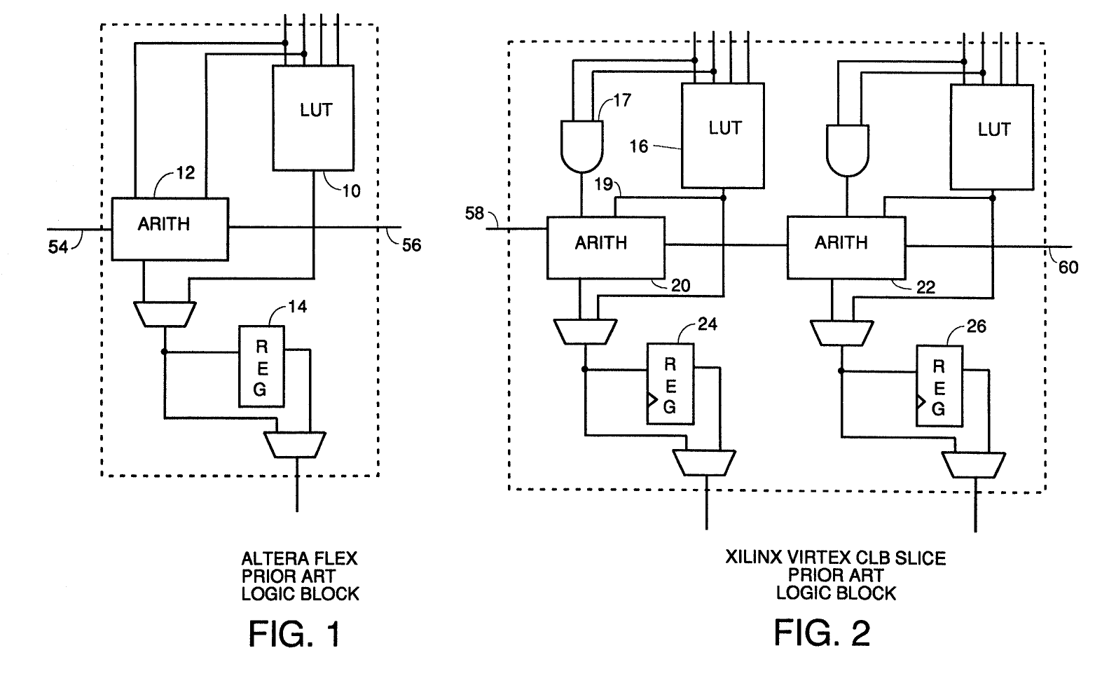

Another important difference over the prior art is that the prior art ALBs of FIGS. 1 and 2 have interconnect lines. Specifically, each ALB has carry-in ports 88, 62, 64 and 66 for coupling to adjacent ALBs in an array for receiving carry-in data, and each ALB has carry-out ports 90, 72, 74 and 76 for outputting carries to adjacent ALBs in an array. These carry-in and carry-out ports allow arrays of ALBs to be coupled together to do math on larger quantities than any individual ALB can work on. In other words, larger quantities are broken down into pieces of the size individual ALBs can process, and arrays of ALBs are programmed to be connected together to process the whole collection of bits at the input to the array. Typically, each ALB is connected by its interconnects to its neighbors in a row of the array so that carries propagate to the neighbors rapidly on the interconnects without going through the programmable switches or fusible links of the FPGA routing structure.

ALB 30 of FIG. 3 also uses interconnects for carry propagation, but the adders use carry lookahead for faster carry propagation. Carries from other ALBs are carried into math circuitry 52 on lines 62, 64 and 66 to adders 68, 70 and 48. These adders all have carry lookahead circuitry so that the outgoing carries can be calculated fast to implement a fast ripple adder. Outbound carries from these adders propagate to other ALBs on lines 72, 74 and 76. The prior art ALBs of FIGS. 1 and 2 do not have carry lookahead adders.

Convolver/partial product generator 80 computes the partial products needed to multiply two input numbers from the operand input buses together. Another way to look at what circuit 80 does is cyclic convolution of two operands on buses 82 and 84. In the multiplication process, this circuit essentially generates the partial products. Buses 88 and 90 allow propagation of 3-bit quantities between neighboring convolver blocks in an array to allow partial products to be computed. Outputs from convolver 80 on buses 92, 94, 86 and 96 to adders 68 and 70 allow partial products to be added.

The circuit of FIG. 3 has the ability to add four 4-bit operands to each other. These operands are input on buses 100, 102, 104 and 106, and are added using 4-bit adders 68 or 70 or a configurable 4-bit or 8-bit adder/subtractor 48. This is done by properly controlling multiplexers 120 and 122 or 124 and 126 or multiplexers 108 and 110 to select the desired operands from any of a number of different sources and apply them to the desired adder. This capability is not present in the Altera or Xilinx prior art we are aware of, and is important in achieving greater computational density in an ALB. In alternative embodiments, the input operand buses 100, 102, 104 and 106 can be wider than 4-bits with a corresponding increase in the capacity of convolver 80, adder 68, adder 70 adder/subtractor 48 and Boolean logic combiner/buffer 32.

By combining the 4-bit values on buses 100 and 102 and the 4-bit values on buses 104 and 106, two 8-bit values can be added or subtracted by 8-bit adder/subtractor 48 by proper control of multiplexers 108 and 110 and properly controlling adder 48 to add or subtract.

The circuit of FIG. 3 also has the ability to do Boolean AND, OR and XOR operations using look up table 32 on 8-bit quantities generated by combining inputs on buses 100, 102, 104 and 106 onto 8-bit quantities on buses 114 and 116 and properly controlling multiplexer 112 to select bus 114 for coupling to bus 36.

The circuit of FIG. 3 also has the ability to store 8-bit operands on buses 36 and 34 in a buffer in circuit 32.

Further the circuit of FIG. 3 has the ability to add 4n-bit values in n/(4+1) cells by: (1) properly controlling multiplexers 120 and 122 to select the quantities on buses 104 and 106 for addition by 4-bit adder 68; (2) properly controlling multiplexers 124 and 126 to select the quantities on buses 100 and 102 for addition in adder 70; and (3) properly controlling multiplexers 108 and 110 to select the quantities on buses 128 and 130 for input to adder 48 and (4) by coupling multiple circuits like FIG. 3 together by connecting the carry-in lines 62, 64, 66 to the carry-out lines 72, 74 and 76 of adjacent cells to make an array that is as big as needed to accomplish the task. In other words, if n=16, by tiling 4 ALBs like that shown in FIG. 3 together in a row, four 16-bit numbers can be added together.

Further the circuit of FIG. 3 has the ability to multiply 4n-bit values in n/(4+1) cells by using partial product generator 80 and coupling multiple circuits like that of FIG. 3 together as an array that is as big as needed to do the job. Thus, a 16×4 multiplier (a multiplier capable of multiplying a 16-bit number by a 4-bit number) would require 5 ALB cells like that shown in FIG. 3. To do this, 4 bits of the 16-bit number would be applied to bus 106 of each of the first four ALBs. The 4-bit operand would then be applied to each bus 104 of the first four ALBs. The last ALB handles carry overflows from the first four ALBs.

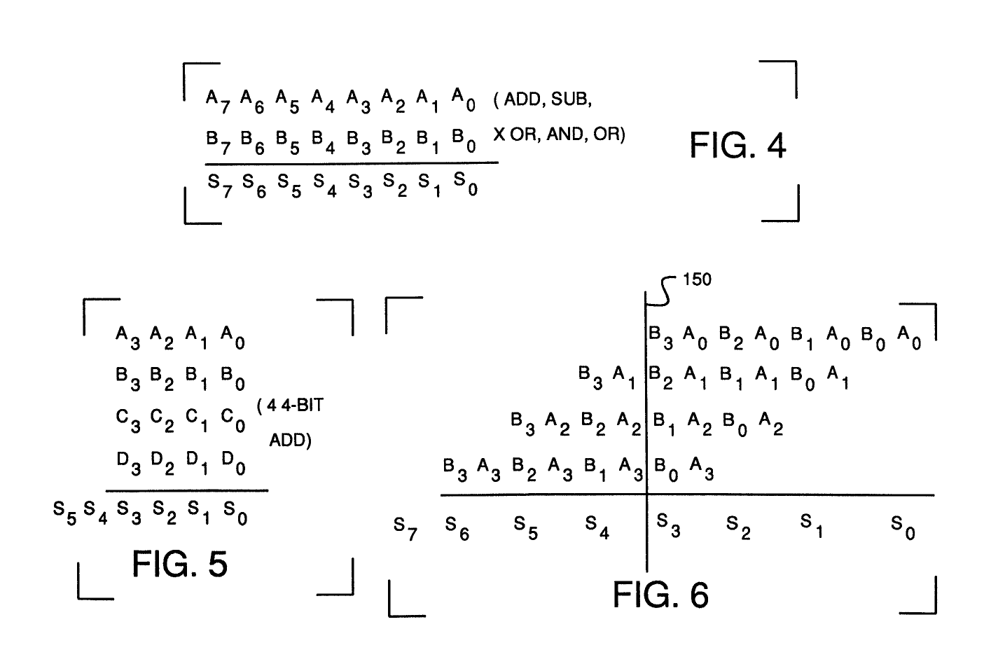

FIGS. 4, 5 and 6 illustrate some primitive operational examples of how the ALB of FIG. 3 can be used to do various mathematical and logical operations. FIG. 4 illustrates how two 8-bit quantities can be added, subtracted, combined by exclusive-OR or a simple OR operation. One 8-bit operand is received on the two 4-bit buses 100 and 102, and the other 8-bit operand is received on the two 4-bit buses 104 and 106, and the mathematical or logical operation is performed by the lookup table 32. FIG. 5 illustrates how 4 4-bit values can be added. FIG. 6 illustrates how partial products are generated and added in the multiplication of two 4-bit numbers using two ALB circuits like that shown in FIG. 3. Line 150 represents the dividing line between the partial products generated by the first ALB (to the right of line 150) and the second ALB (to the left of line 150).

The cell of FIG. 3, when coupled to one other cell like that in FIG. 3 to handle carries, can multiply two 4-bit values arriving on buses 104 and 106 in convolver circuit 80.

By tiling a row of cells like that shown in FIG. 3 together, large numbers can be added or multiplied.

These capabilities give the ALB according to the invention an approximate 5× improvement in cell size over the Virtex prior art, and an approximate 10× improvement in cell size over the Altera/Dynachip prior art chips. The same improvements are expected for multiply and accumulate operations.

For primitive operations, for Xilinx and Dynachip prior art ALBs, all XOR/AND/OR, ADD and ACC operations require n/2 cells to implement. The Altera prior art ALBs require n cells to do these same operations. In contrast, the ALB of the invention, such as the species shown in FIG. 3, only requires n/8 cells to perform all XOR/AND/OR, ADD and ACC operations on n bit quantities. This represents an approximate 4× improvement over the prior art cells assuming similar cell die area sizes.

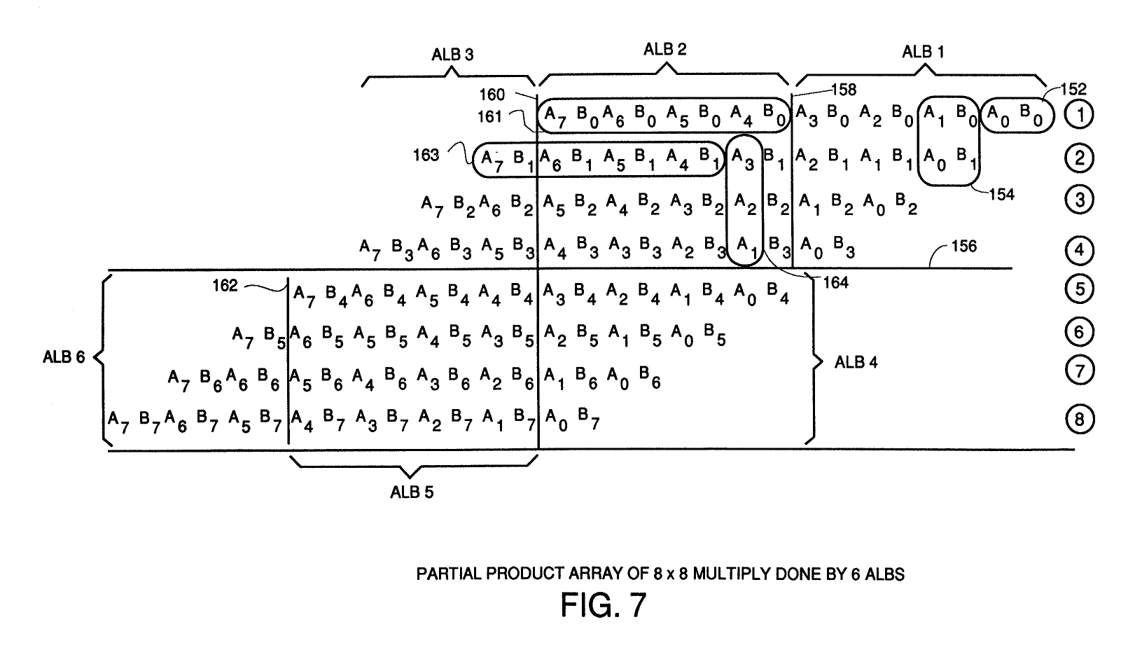

FIG. 7 represents a partial product array generated by use of six ALBs according to the invention for an 8×8 binary multiply. These partial products must be added to arrive at a final result. The quantity at 152 represents the first partial product of the multiplication and also represents the first bit of the result. The sum of the two partial products within circle 154 represents the second bit of the result. Each partial product represents an output from the convolve block 80 in FIG. 3. Each partial product is the AND of the two designated bits. Partial product 152 is therefore the AND of bit B₀ of the B operand and bit A₀ of the A operand.

Six ALBs like that shown in FIG. 3 are used to generate the partial products shown in FIG. 7. The partial products above line 156 and to the right of line 158 are generated by ALB 1. The partial products above line 156 and to the left of line 158 and to the right of line 160 are generated by ALB 2. The partial products to the left of line 160 and above line 156 are generated by ALB 3. The partial products below line 156 and to the right of line 160 are generated by ALB 4. The partial products to the left of line 160 and below line 156 are generated by ALB 5. The partial products to the left of line 162 and below line 156 are generated by ALB 6.

Some of the bits are input to one ALB but are actually ANDed in another ALB with other bits input to the other ALB. For example, the bits inside perimeter 164 are actually input to ALB 1 but are output on line 90 in FIG. 3 to ALB 2 for ANDing with bits B₁, B₂ and B₃, respectively, which are input to ALB 2 as well as to ALB 1 and ALB 3. The partial products above line 156 represent partial products that are generated by a row comprised of ALB 1, ALB 2 and ALB 3. The B₀ through B₃ bits are applied to each of ALB 1, ALB 2 and ALB 3.

Multiplexers 120 and 122 control the inputs of the adder 68 so that it can either add the two outputs of convolver block 80 on buses 92 and 94 or add the 4-bit input quantities at inputs 104 and 106. Likewise, multiplexers 124 and 126 control the inputs to adder 70 so that it may add either the two outputs on buses 86 and 96 output by the convolver 80 or the 4-bit inputs on inputs 100 and 102. Each of outputs 92, 94, 86 and 96 represent one of the rows of four partial products in FIG. 7. For example, output 96 carries the four partial products inside circle 161. Output 86 carries the four partial products inside circle 163, and adder 70 adds these two rows of partial products. Likewise, adder 68 can add two 4-bit partial products output by the convolver 80 on buses 92 and 94. Adder 48 and multiplexers 108 and 110 are then controlled to add the 8-bit results generated by adders 68 and 70. However, by properly controlling multiplexers 108 and 110, adder 48 can also be used to add two 8-bit quantities concatenated together from two 4-bit quantities on buses 100 and 102 and buses 104 and 106. By using multiple ALBs and controlling the multiplexers properly, all the partial products in FIG. 7 can be generated and added to do binary multiplication of two 8-bit numbers.

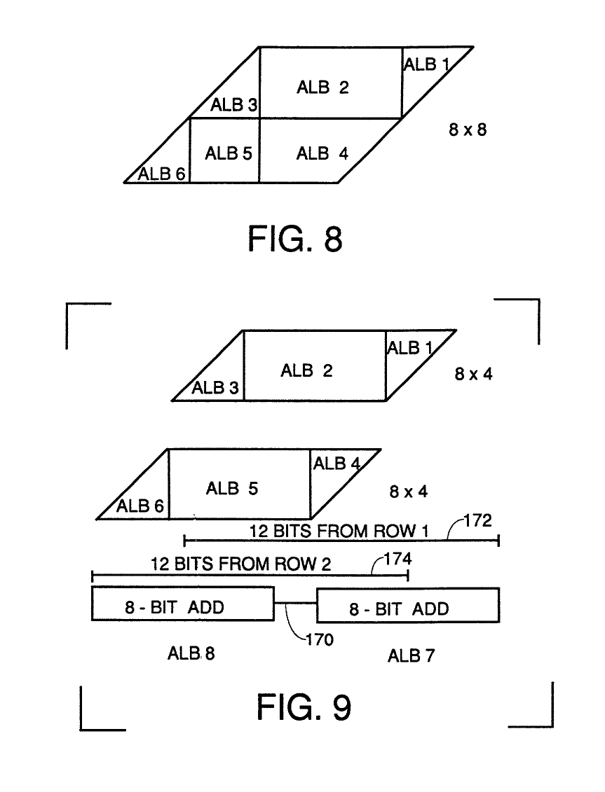

FIG. 8 shows in block form the array of 6 ALBs that are used to form the partial products of the 8×8 multiply operation. The first three ALBs form the first row and ALBs 4, 5 and 6 form a second row. ALB 1 through ALB 3 forms an 8×4 multiplier, and ALB 4 through ALB 6 forms another 8×4 multiplier, as shown in FIG. 9. These two 8×4 multipliers each add their own set of partial products and generates a 12-bit result. The results of the two 12-bit results of the 8×4 multiplications are represented by lines 172 and 174 in FIG. 9. These two results are then added using two additional ALBs 7 and 8 each of which does an 8-bit add with carries transmitted from ALB 7 to ALB 8 via link 170. The addition by ALB 7 and ALB 8 causes the first bit of the result to be simply A₀ ANDed with B₀. The second bit of the result however is the sum [A₁ ANDed with B₀] plus [A₀ ANDed with B₁].

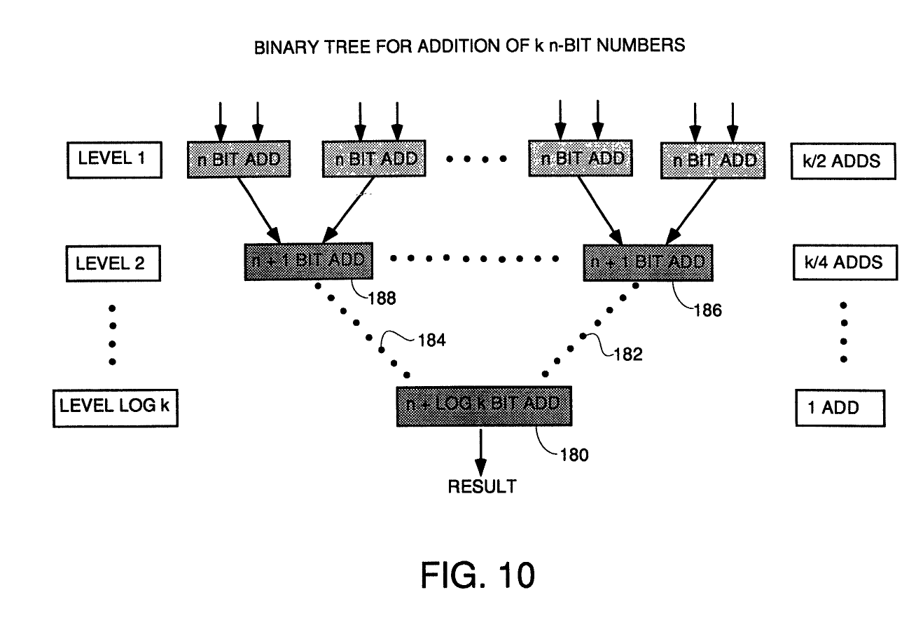

FIG. 10 shows how ALBs of the invention could be configured to form a binary tree to add k n-bit numbers to perform the additions of the partial products of FIG. 7. Because each ALB has two 4-bit adders that can feed the inputs of an 8-bit adder, the structure of FIG. 10 can be implemented with fewer ALBs according to the teachings of the invention than with prior art ALBs. Each adder in FIG. 10 is one ALB and accepts two input operands and outputs one result to act as an input operand for another adder in the same ALB or another ALB. Adder 180 receives at input 182 the sum of all the rows of partial products above line 156 in FIG. 7, and receives at input 184 the sum of all the rows of partial products below line 156 in FIG. 7. Likewise, adder 186 adds the sum of rows 1 and 2 to the sum of rows 3 and 4, and adder 188 adds the sum of rows 5 and 6 to the sum of rows 7 and 8.

The ALBs of the invention can actually be used to implement the the binary tree of FIG. 10 more efficiently, i.e., using less ALB circuits that using a separate ALB for each adder in the binary tree. This is because each ALB according to the invention has three adders. Because of the structure of the ALB of the invention, each of rows 1 through 4 can be added in one ALB and each of rows 5 through 6 can be added in another ALB. This reduces the number of levels of the binary tree need to perform the necessary additions of partial products or additions of k n-bit numbers. Because the binary tree is smaller, the number of cells needed is also smaller to do any particular addition problem.

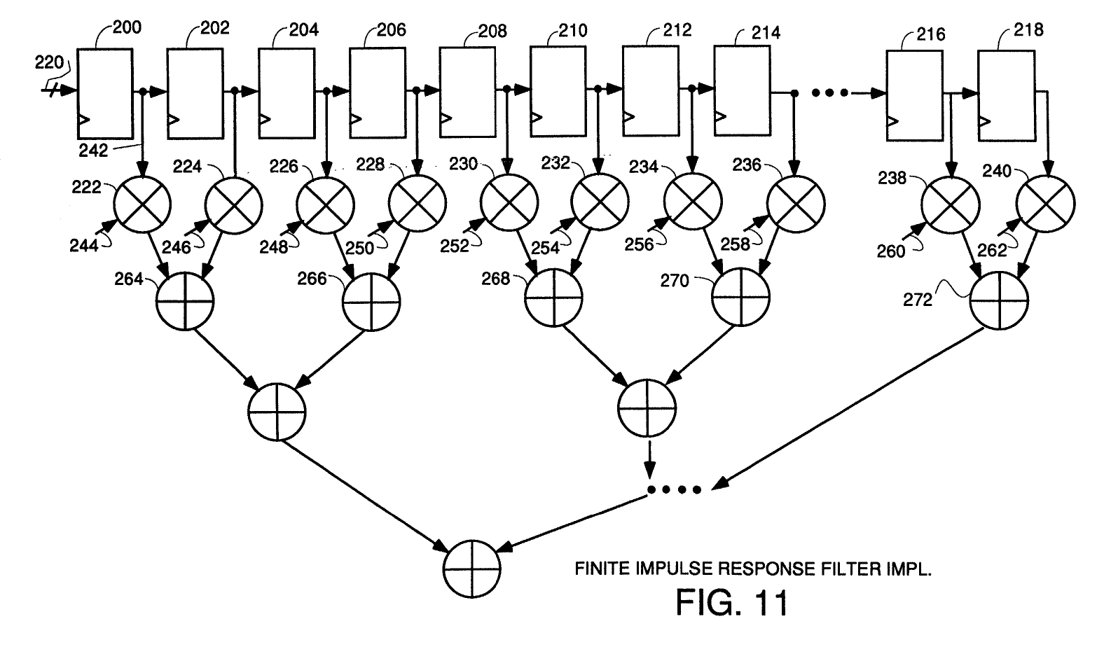

Referring to FIG. 11, there is shown a block diagram illustrating how the invention can be used to create a finite impulse response filter. Blocks 200 through 218 are registers that are coupled as a delay line to store input data to be filtered. The input data arrives on line 220 in serial or multibit parallel format and is shifted sequentially through the registers. If the input is multibit, each register block represents enough to store all the bits received on bus 220 during one clock cycle. Each of circles 222 through 240 represents a multiplier which has an input coupled to a different tap on the delay line. Each tap such as bus 242 usually has the same number of bits as the number of bits on line 220 but it can have less. Each of the multipliers multiplies the bits on its tap by the value of a tap weighting coefficient which is either hardwired or, more preferably, is supplied from an outside source, as represented by inputs 244 through 262. The larger the number of bits in each coefficient, the more accurate the filter is.

As the input data propagates through the delay line, each tap represents a sample of the input signal at a different time. The coefficients for each tap are different, and the values of those coefficients set the filter characteristics such as the frequency response and rolloff frequency, etc.

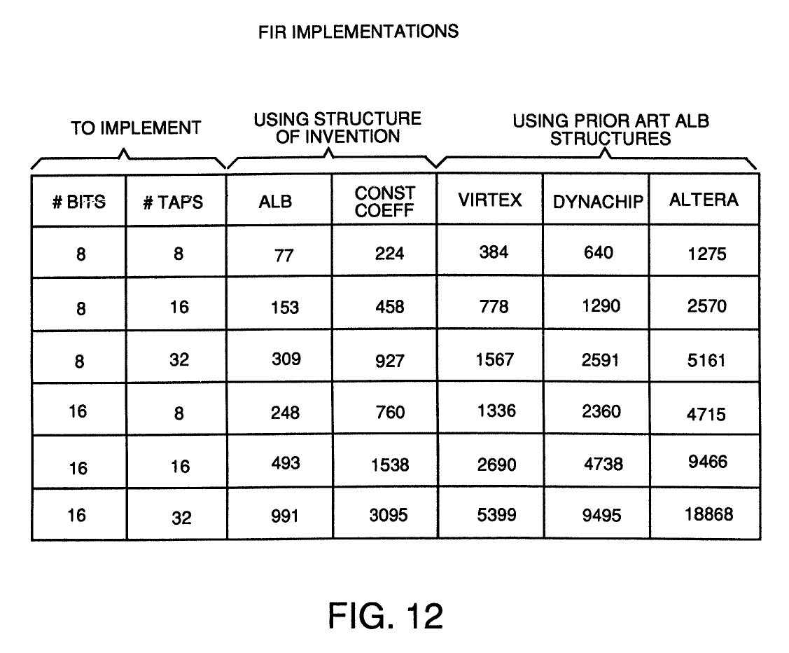

Each of circles 264 through 272 is an adder which adds two of the results output by the multipliers 222 through 240. The invention of FIG. 3 can be used to implement multiple ones of the multipliers and adders in FIG. 11 in one integrated circuit since the invention can add up to four numbers in a row of ALBs like that shown in FIG. 11. FIG. 12 is a table which shows the affect of using the ALB structure of the invention to implement various FIR implementations as compared to using prior art ALB structures by Virtex, DynaChip and Altera. To build an FIR with an 8-bit input with 8 taps, would take 77 ALBs with 224 constant coefficients using the invention. Using a Virtex prior art structure, 384 coefficients would have to be used, and with the prior art DynaChip structure, 640 coefficients would have to be used. Using the Altera prior art structure, 1275 coefficients would have to be used.

Although the invention has been disclosed in terms of the preferred and alternative embodiments disclosed herein, those skilled in the art will appreciate possible alternative embodiments and other modifications to the teachings disclosed herein which do not depart from the spirit and scope of the invention. All such alternative embodiments and other modifications are intended to be included within the scope of the claims appended hereto.

What is claimed is:

1. A reconfigurable arithmetic logic block, comprising:
first, second, third and fourth multi-bit operand input buses;
a convolver circuit having first and second inputs coupled to said first and second input buses and having first, second, third and fourth output buses at which multi-bit partial products appear, and having a multi-bit carry input and a multi-bit carry output, each for coupling to neighboring arithmetic logic blocks in an array to allow partial product generation in said array;
a first multiplexer having a first input coupled to receive the bits on said first and second operand input buses, and having an output coupled to said first input of said Boolean logic means, and having a second input coupled to receive an output signal from said arithmetic logic block, and having a control input to receive a switching control signal;
a first adder having a first operand input and a second operand input and having an output, and having a carry input and a carry output for coupling to neighboring arithmetic logic blocks;
a second multiplexer having an output coupled to said first operand input of said first adder and having a first input coupled to said third operand input bus and having a second input coupled to said first output of said convolver circuit, and having a control input for receiving a switching control signal;
a third multiplexer having an output coupled to said second operand input of said first adder and having a first input coupled to said fourth operand input bus and having a second input coupled to said second output of said convolver circuit, and having a control input for receiving a switching control signal;
a second adder having a first operand input and a second operand input and having an output, and having a carry input and a carry output for coupling to neighboring arithmetic logic blocks;
a fourth multiplexer having an output coupled to said first operand input of said second adder and having a first input coupled to said first operand input bus and having a second input coupled to said third output of said convolver circuit, and having a control input for receiving a switching control signal;
a fifth multiplexer having an output coupled to said second operand input of said second adder and having a first input coupled to said second operand input bus and having a second input coupled to said fourth output of said convolver circuit, and having a control input for receiving a switching control signal;
a third adder having a first operand input and a second operand input and having an output, and having a carry input and a carry output for coupling to neighboring arithmetic logic blocks;
a sixth multiplexer having an output coupled to said first operand input of said third adder and having a first input coupled to receive the bits of said first and second operand input buses and having a second input coupled to said output of said first adder, and having a control input for receiving a switching control signal;
a seventh multiplexer having an output coupled to said second operand input of said third adder and having a first input coupled to receive the bits of said third and fourth operand input buses and having a second input coupled to said output of said second adder, and having a control input for receiving a switching control signal;
an eighth multiplexer having a first input coupled to said output of said Boolean logic means and having a second input coupled to said output of said third adder, and having an output and a control input to receive a switching control signal;
a register having a data input coupled to said output of said eighth multiplexer and having an output; and
a ninth multiplexer having a first input coupled to said output of said register, and having a second input coupled to said output of said eighth multiplexer and having an output coupled to said second input of said first multiplexer and also serving as the output of said arithmetic logic block.

2. The apparatus of claim 1 further comprising:
a multibit Boolean logic means having first and second inputs and an output, said second input coupled to receive the bits on said third and fourth operand input buses for performing a selected operation on the input bits at said first and second inputs and outputting the result at said output;

3. An arithmetic logic block comprising:
a plurality of input buses for receiving operands;
a plurality of carry-in and carry-out interconnects;
a convolver input port and a convolver output port;
first arithmetic means coupled to said plurality of input buses and to said plurality of carry-in and carry-out interconnects for selectively either adding or subtracting either four 4-bit quantities or two 8-bit quantities;
multiplication means coupled to said plurality of input buses and coupled to said convolver input port and said convolver output port, and coupled to said first arithmetic means, for performing cyclic convolution or multiplication on a plurality of operands to generate partial products which are output to said first arithmetic means for adding together, and for receiving multibit quantities from other arithmetic logic blocks in an array, if any, to aid in generating said partial products, and for propagating multibit quantities to other arithmetic logic blocks in an array, if any, to aid multiplication means in said other arithmetic logic blocks to generate partial products.

4. The apparatus of claim 3 further comprising:
logic means coupled to said input buses for performing selectable Boolean logic operations including AND, OR and exclusive-OR operations on multibit operands received via and input buses, and, selectively, for buffering multibit operands received from said input buses;

5. The apparatus of claim 3 wherein said first arithmetic means uses carry look ahead adders.

6. The apparatus of claim 4 wherein said logic means uses look up tables to perform said Boolean logic operations.

7. An array of arithmetic logic blocks, comprising:
a plurality of arithmetic logic blocks interconnected by an interconnect structure, each arithmetic logic blocks comprising:
a plurality of input buses for receiving operands;
a plurality of carry-in and carry-out interconnects;
a convolver input port and a convolver output port;
logic means coupled to said input buses for performing selectable Boolean logic operations including AND, OR and exclusive-OR operations on multibit operands received via and input buses, and, selectively, for buffering multibit operands received from said input buses;
first arithmetic means coupled to said plurality of input buses and to said plurality of carry-in and carry-out interconnects for selectively either adding or subtracting either four 4-bit quantities or two 8-bit quantities;
multiplication means coupled to said plurality of input buses and coupled to said convolver input port and said convolver output port, and coupled to said first arithmetic means, for performing cyclic convolution or multiplication on a plurality of operands to generate partial products which are output to said first arithmetic means for adding together, and for receiving multibit quantities from other arithmetic logic blocks in an array, if any, to aid in generating said partial products, and for propagating multibit quantities to other arithmetic logic blocks in an array, if any, to aid multiplication means in said other arithmetic logic blocks to generate partial products;
and wherein each said arithmetic logic block is configured in such a way and said interconnect structure couples said arithmetic logic blocks together in such a way that the array can be used to accomplish a selected function.

8. The apparatus of claim 7 wherein said configuration of said arithmetic logic blocks and said interconnect structure is structured so as to allow the array to be used to add 4n-bit values using n/(4+1) arithemetic logic blocks.

9. The apparatus of claim 7 wherein said configuration of said arithmetic logic blocks and said interconnect structure is structured so as to allow the array to be used to multiply 4n-bit values using n/(4+1) arithemetic logic blocks.

10. The apparatus of claim 7 wherein said configuration of said arithmetic logic blocks and said interconnect structure is structured so as to allow the array to be used to do an 8×8 binary multiplication.

11. The apparatus of claim 7 wherein said configuration of said arithmetic logic blocks and said interconnect structure is structured so as to allow the array to be structured as a binary tree and used to add k n-bit numbers or partial products.

12. The apparatus of claim 7 wherein said configuration of said arithmetic logic blocks and said interconnect structure is structured so as to allow the array to be structured as and function as a finite impulse response filter.
